(19) United States
(12) Patent Application Publication
(10) Pub. No.: US 2013/0228074 A1
(43) Pub. Date: Sep. 5, 2013

(54) METHODS AND APPARATUSES FOR INHIBITING BACKFLOW OF LIQUID INTO ENGINE DUCTS ON A SHIP

(71) Applicants: Ronald G. Patterson, San Diego, CA (US); Andrew J. Olds, San Diego, CA (US)

(72) Inventors: Ronald G. Patterson, San Diego, CA (US); Andrew J. Olds, San Diego, CA (US)

(21) Appl. No.: 13/412,461

(22) Filed: Mar. 5, 2012

(51) Int. Cl. B01D 53/18; B01F 3/04

(52) U.S. Cl. 95/226; 261/74; 261/36.1

(57) ABSTRACT

Methods and apparatuses for inhibiting backflow of liquid into an engine duct on a ship are provided. In an embodiment, a gas processing apparatus includes an engine producing exhaust gases. The apparatus also includes a processing vessel having a bottom end. The processing vessel is formed with an inlet, a riser having a riser opening, and a liquid outlet positioned between the bottom end and the riser opening. Further, a duct connects the engine to the processing vessel to flow the exhaust gases into the processing vessel. A secondary basin is positioned below the bottom end of the processing vessel. Also, a pipe connects the liquid outlet of the processing vessel to the secondary basin and is configured to flow liquid from the bottom end of the processing vessel into the secondary basin under force of gravity to prevent liquid from entering the riser opening.

### TECHNICAL FIELD

The present disclosure generally relates to methods and apparatuses for inhibiting backflow of liquid into engine ducts on a ship, and more particularly relates to methods and apparatuses that provide a secondary basin to hold liquid below entrances to engine ducts.

### BACKGROUND

As is well known, the combustion of hydrocarbon-containing fuels, such as diesel, results in exhaust gases. Before emitting the exhaust gases, they must be processed to remove or reduce levels of pollutants therein. Typically such processing may include particulate removal, scrubbing, or other operations.

Because land-based combustion plants are stationary, they need not be designed for tilting or rocking of their components. However, shipboard plants must accommodate for tidal movements, tilting, and rocking As a result precautions not normally taken on land much be made. For instance, shipboard plants must provide for containment of liquids that would otherwise slosh around or move to inappropriate locations in the plants. Further, unwanted motion of liquids within a shipboard plant may result in the backflow of liquid into gas exhaust ducts and even into the plant engine.

In light of the above, the present disclosure provides a method and apparatus for inhibiting the backflow of liquid into engine ducts on a ship. Further, the present disclosure provides a method and apparatus for collecting liquids used in a gas processing vessel in a secondary basin positioned below the processing vessel. Alternative or additional features and characteristics of the methods and apparatuses will become apparent from the subsequent detailed description and the appended claims, taken in conjunction with the accompanying drawings and this background.

### BRIEF SUMMARY

Methods and apparatuses for inhibiting backflow of liquid into an engine duct on a ship are provided. In accordance with an exemplary embodiment, a gas processing apparatus includes an engine producing exhaust gases. The apparatus also includes a processing vessel having a bottom end. The processing vessel is formed with an inlet, a riser having a riser opening, and a liquid outlet positioned between the bottom end and the riser opening. Further, a duct connects the engine to the processing vessel to flow the exhaust gases into the processing vessel. A secondary basin is positioned below the bottom end of the processing vessel. Also, a pipe connects the liquid outlet of the processing vessel to the secondary basin and is configured to flow liquid from the bottom end of the processing vessel into the secondary basin under force of gravity to prevent liquid from entering the riser opening.

In another embodiment, a shipboard apparatus for processing gas with liquid includes a processing vessel for processing exhaust gases with the liquid. The processing vessel is formed with an inlet configured to receive the exhaust gases, a riser having a riser opening, and a liquid outlet positioned below the riser opening. Also, the shipboard apparatus includes a secondary basin positioned below the processing vessel and connected to the liquid outlet. In the apparatus, liquid flows out of the processing vessel through the liquid outlet and into the secondary basin under force of gravity to prevent liquid from entering the riser opening.

In accordance with another exemplary embodiment, a method is provided for inhibiting backflow of liquid into an engine duct on a ship. The method includes providing a processing vessel having a vessel wall and a bottom end and formed with an inlet, a riser having a riser opening, and a liquid outlet positioned between the bottom end and the riser opening. Further, the method includes providing a secondary basin positioned below the bottom end of the processing vessel. In the method, liquid is collected in the bottom end of the vessel. The collected liquid is flowed out of the vessel through the liquid outlet and into the second basin under force of gravity and liquid is inhibited from entering the riser opening.

### BRIEF DESCRIPTION OF THE DRAWINGS

Exemplary embodiments will hereinafter be described in conjunction with the following drawing figures, wherein like numerals denote like elements, and wherein:

FIG. 1 is a schematic view of an apparatus for processing gases on a ship in accordance with exemplary embodiments;

FIG. 2 is a cross sectional view of a processing vessel for use in the apparatus of claim 1 in accordance with exemplary embodiments.

### DETAILED DESCRIPTION

The following detailed description is merely exemplary in nature and is not intended to limit the methods and apparatuses for inhibiting backflow of liquid into engine ducts on a ship as claimed herein. Furthermore, there is no intention to be bound by any theory presented in the preceding background or the following detailed description.

As detailed below, the methods and apparatuses for inhibiting backflow of liquid into engine ducts on a ship utilize a secondary basin positioned below a processing vessel to receive and hold liquid below riser openings in communication with engine ducts. As a result, there is not liquid build up inside the processing vessel and little to no risk of liquid entering riser openings within the processing vessel.

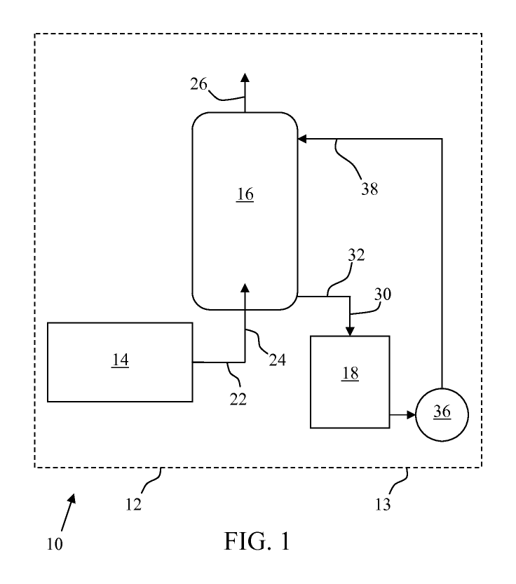

In FIG. 1, a processing apparatus is shown and generally designated 10. The processing apparatus 10 is located on a ship 12 having a bottom 13 and includes a diesel engine 14, a processing vessel 16 such as a scrubber, and a secondary basin 18. The diesel engine 14 creates a stream of exhaust gases 22 that are delivered to the processing vessel 16 through a duct 24. Processed gases 26 exit the processing vessel 16 as shown. While the exemplary processing vessel 16 may incorporate any of a variety of means for processing exhaust gases, it is contemplated herein that water, as well as other liquids to enhance processing, is used in processing. As shown, a pipe 30 connects the processing vessel 16 to the secondary basin 18. As a result, a liquid such as water 32 may exit the processing vessel 16 and flow to the secondary basin 18 through the pipe 30. The secondary basin 18 is positioned below the processing vessel 16, i.e., between the processing vessel 16 and the bottom 13 of the ship 12, such that water 32 will flow from the processing vessel 16 to the secondary basin due to gravity. As shown, the apparatus 10 includes a pump 36 to pump recycled water 38 to the processing vessel 16 for reuse in processing.

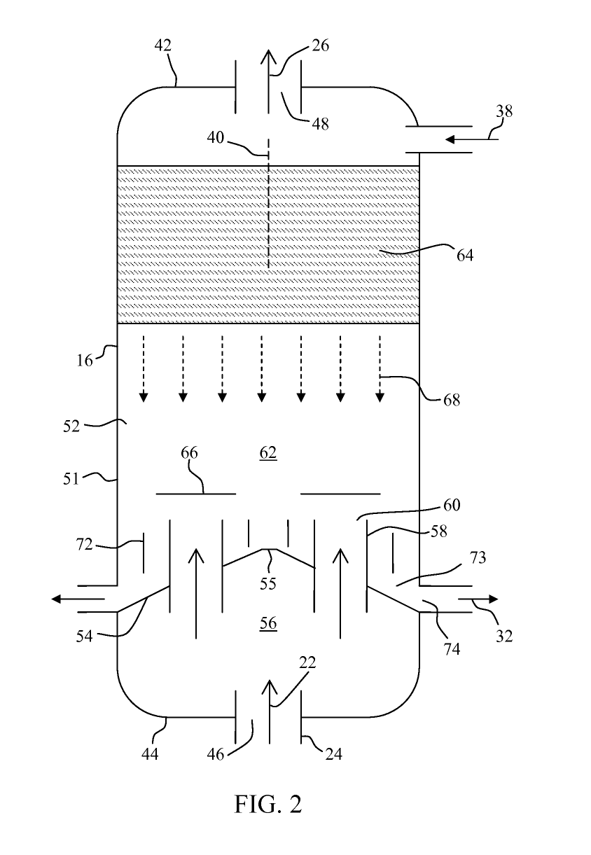

Referring now to FIG. 2, the structure and connections of processing vessel 16 may be more specifically explained. As shown, the processing vessel 16 defines a central axis 40 and has a top end 42 and a bottom end 44. The bottom end 44 is formed with an inlet 46 in communication with the duct 24 to receive the exhaust gases 22 from the diesel engine 14. The top end 42 is formed with an outlet 48 through which the processed gases 26 may exit the processing vessel 16.

The vessel 16 can be of any shape, such as cylindrical, rectangular, or other. The processing vessel 16 shown in FIG. 2 has a wall 51 defining a chamber 52. A barrier 54 bounds an inlet zone 56 in the chamber 52 at the bottom end 44 of the vessel 16. The barrier 54 seals the inlet zone 56 from a processing zone 62 above. Specifically, the barrier 54 forms an annular seal with the wall 51, preventing any liquid flow downward into the inlet zone 56. The exemplary barrier 54 has a circumference along the wall 51 and a peak 55 at the central axis 40. The barrier 54 slopes downwardly in each direction from the peak 55 to the vessel wall 51. In the exemplary vessel 16, the barrier 54 forms an angle of about 80° with the vessel wall 51 in the processing zone 62 (and an angle of about 100° with the vessel wall in the inlet zone 56). Depending on the design of the vessel 16, the peak 55 will be about six inches to about thirty-six inches higher than the junction of the barrier 54 and the vessel wall 51. As a result, water will flow downward to the vessel wall 51 despite extreme rocking or tidal action on the ship.

Risers 58 pass through the barrier 54 and extend to openings 60 that are positioned in the processing zone 62. While two risers 58 are illustrated, the vessel 16 can be provided with six, eight, or more risers 58 as desired. Further, in certain embodiments, the vessel 16 will include a riser 58 along the central axis 40 and the peak 55 of the barrier 54 will surround that central riser. As shown, the processing zone 62 is bounded by the barrier 54 and by a second processing mechanism 64, such as a vapor-liquid contact mechanism or other gas processing device. The exemplary processing zone 62 may include splash or diffusion plates 66. Each plate 66 is positioned at a riser opening 60 to provide a selected flow path to diffuse the flow of exhaust gases 22 into the processing zone 62. Further, the plates 66 block or inhibit falling water drops 68 from entering the risers 58. Typically, any water droplets 68 that enter the risers 58 are atomized and carried back into the quench zone 62 by the flow of exhaust gases 22. The exemplary vessel 16 is further provided with baffles 72 that inhibit movement of any water collected on the barrier 54. As shown, the baffles 72 do not contact the barrier 54, leaving a pathway 73 for liquid to flow along the barrier 54 to the vessel wall 51.

As shown, the vessel 16 is formed with a plurality of water outlets 74 in the vessel wall 51 adjacent the barrier 54. As shown, the water outlets 74 are formed below the level of the riser openings 60, i.e., between the riser openings 60 and the bottom end 44 of the vessel 16. Water 32 landing on the barrier 54 flows toward the vessel wall 51 and out of the vessel 16 through the outlets 74 to the secondary basin 18 under the force of gravity. As a result, water does not rise to the level of the riser openings 60 and cannot backflow into the risers 58 toward the engine 14. Such backflow is prevented even in rocking conditions experienced by the ship 12 on rough seas. As noted in FIG. 1, the water 32 received in the secondary basin 18 may be pumped and recycled to the top end 42 of the vessel 16 for reuse in processing.

While the particular methods and apparatuses for inhibiting backflow of liquid into engine ducts on a ship as herein shown and disclosed in detail are fully capable of obtaining the objects and providing the advantages herein before stated, it is to be understood that they are merely illustrative of exemplary embodiments and that no limitations are intended to the details of construction or design herein shown other than as described in the appended claims.

What is claimed is:

1. A gas processing apparatus on a ship comprising:
an engine producing exhaust gases;
a processing vessel having a bottom end and formed with an inlet, a riser having a riser opening, and a liquid outlet positioned between the bottom end and the riser opening;
a duct connecting the engine to the processing vessel to flow the exhaust gases into the processing vessel;
a secondary basin positioned below the bottom end of the processing vessel; and
a pipe connecting the liquid outlet of the processing vessel to the secondary basin and configured to flow liquid from the bottom end of the processing vessel into the secondary basin under force of gravity to prevent liquid from entering the riser opening.

2. The gas processing apparatus of claim 1 wherein the processing vessel is a scrubber, and wherein the liquid falls from a top end of the scrubber to the bottom end during processing.

3. The gas processing apparatus of claim 2 further comprising a pump configured to recycle the water from the secondary basin to the top end of the scrubber.

4. The gas processing apparatus of claim 1 wherein the processing vessel is formed with baffles at the bottom end configured to inhibit movement of the liquid.

5. The gas processing apparatus of claim 4 wherein a liquid pathway is formed between the baffles and the bottom end of the processing vessel.

6. The gas processing apparatus of claim 1 wherein the processing vessel is formed with a barrier near the bottom end, wherein the riser passes through the barrier, wherein the liquid is collected on the barrier, and wherein the liquid outlet is positioned adjacent the barrier.

7. The gas processing apparatus of claim 6 wherein the processing vessel defines a central axis and wherein the barrier slopes downward from the central axis.

8. The gas processing apparatus of claim 7 wherein the processing vessel is formed with a plurality of liquid outlets positioned between the bottom end and the riser opening, and wherein each liquid outlet is connected to the secondary basin.

9. The gas processing apparatus of claim 1 wherein the vessel includes a vessel wall and a barrier connected to the vessel wall, and wherein the liquid outlets are formed in the vessel wall adjacent the barrier.

10. The gas processing apparatus of claim 9 wherein the processing vessel defines a central axis, wherein the barrier has a peak along the central axis, and wherein the barrier slopes downward from the central axis to the vessel wall.

11. The gas processing apparatus of claim 1 wherein the ship has a bottom, and wherein the secondary basin is positioned between the bottom end of the processing vessel and the bottom of the ship.

12. A shipboard apparatus for processing gas with liquid comprising:
a processing vessel for processing exhaust gases with the liquid, the processing vessel formed with an inlet configured to receive the exhaust gases, a riser having a riser opening, and a liquid outlet positioned below the riser opening; and
a secondary basin positioned below the processing vessel and connected to the liquid outlet, wherein liquid flows out of the processing vessel through the liquid outlet and into the secondary basin under force of gravity to prevent liquid from entering the riser opening.

13. The shipboard apparatus of claim 12 wherein the processing vessel is formed with a liquid barrier, wherein the riser passes upwardly through the barrier, wherein the liquid is collected on the barrier, and wherein the liquid outlet is positioned adjacent the barrier.

14. The shipboard apparatus of claim 13 wherein the processing vessel defines a central axis and wherein the barrier slopes downward from the central axis.

15. The shipboard apparatus of claim 14 wherein the processing vessel is formed with a plurality of liquid outlets positioned below the riser opening, and wherein each liquid outlet is connected to the secondary basin.

16. The shipboard apparatus of claim 12 wherein the vessel includes a vessel wall and a liquid barrier connected to the vessel wall, wherein the riser passes upwardly through the liquid barrier, and wherein the liquid outlet is formed in the vessel wall adjacent the liquid barrier.

17. The shipboard apparatus of claim 16 wherein the processing vessel defines a central axis, wherein the liquid barrier has a peak along the central axis, and wherein the liquid barrier slopes downward from the central axis to the vessel wall.

18. The shipboard apparatus of claim 17 wherein the ship has a bottom, and wherein the secondary basin is positioned between the processing vessel and the bottom of the ship.

19. A method for inhibiting backflow of liquid into an engine duct on a ship comprising:
providing a processing vessel having a vessel wall and a bottom end and formed with an inlet, a riser having a riser opening, and a liquid outlet positioned between the bottom end and the riser opening;
providing a secondary basin positioned below the bottom end of the processing vessel;
collecting liquid in the bottom end of the vessel; and
flowing the collected liquid out of the vessel through the liquid outlet and into the second basin under force of gravity and inhibiting liquid from entering the riser opening.

20. The method of claim 19 further comprising providing the processing vessel with a liquid barrier in the bottom end of the vessel, wherein the liquid barrier slopes from a central peak to the vessel wall, and wherein the liquid outlet is positioned adjacent the liquid barrier.
